(19) United States
(12) Patent Application Publication
(10) Pub. No.: US 2009/0091535 A1
(43) Pub. Date: Apr. 9, 2009

(54) Keyboard with touch-sensor space bar

(76) Inventor: Michael J. Ure, Cupertino, CA (US)

Correspondence Address: MICHAEL J. URE, 10518 PHIL PLACE, CUPERTINO, CA, 95014, US

(21) Appl. No.: 11/867,644

(22) Filed: Oct. 4, 2007

(51) Int. Cl. G06F 3/02

(52) U.S. Cl. 345/168

(57) ABSTRACT

A keyboard is provided with a touch sensor incorporated within a space bar thereof, allowing for cursor manipulation in two dimensions. The keyboard may be a split keyboard having an enlarged space bar. The touch sensor may be operated with the thumb of the user without removal of the user's fingers from the keyboard.

### BACKGROUND

1. Field of the Invention

The present invention relates to computer keyboards.

2. State of the Art

Computer keyboards are known that incorporate touch sensors. One example is a keyboard that incorporates a rectangular-shaped touchpad along a bottom edge of the keyboard. Another example is a split keyboard that incorporates a touch strip (used for scrolling) in the median area of the keyboard. Other pointing devices have been combined with a computer keyboard, for example the “pointing stick.” Most users of desktop computers, however, use a conventional computer mouse almost exclusively, requiring that the mouse hand be moved back and forth between the keyboard and the mouse.

### SUMMARY

A keyboard is provided with a touch sensor incorporated within a space bar thereof, allowing for cursor manipulation in two dimensions. The keyboard may be a split keyboard having an enlarged space bar. The touch sensor may be operated with the thumb of the user without removal of the user's fingers from the keyboard.

### DESCRIPTION OF DRAWING

The foregoing may be further understood from the following description in conjunction with the appended drawing. In the drawing:

FIG. 1 is a plan view of a keyboard incorporating a touch sensor within the space bar.

FIG. 2 is a block diagram of one embodiment of the keyboard of FIG. 1.

### DETAILED DESCRIPTION

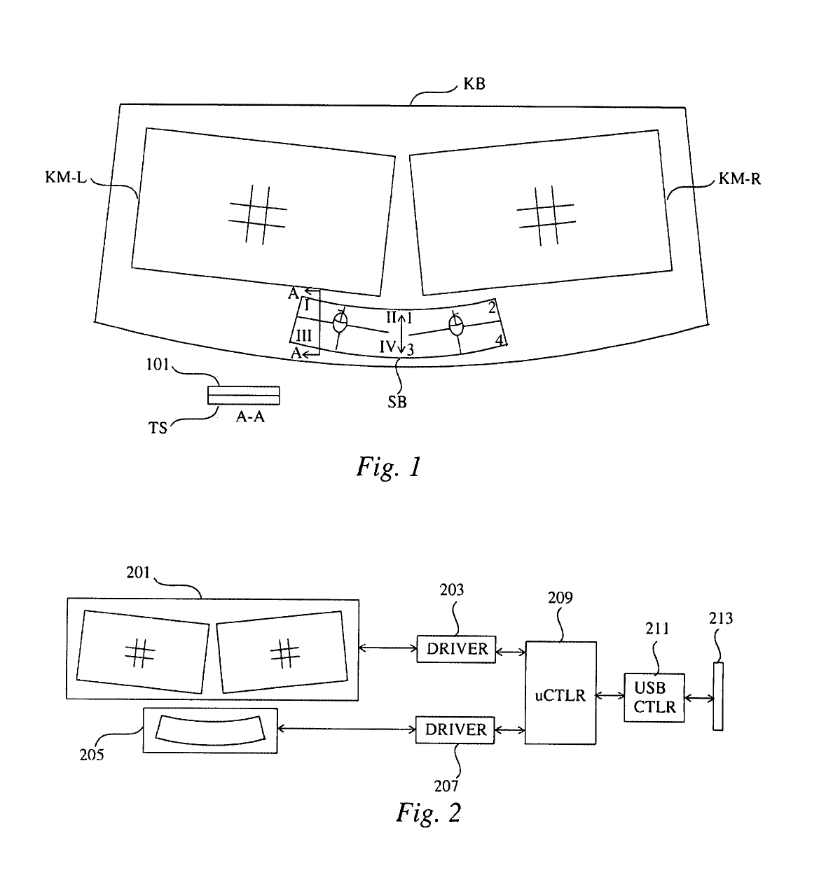

Referring now to FIG. 1, there is shown a schematic plan view of a keyboard incorporating a touch sensor within a space bar thereof. In the illustrated embodiment, the keyboard KB is a split keyboard having a right key matrix KM-R, a left key matrix KM-L, and a space bar SB. The right key matrix and the left key matrix are angled to form a triangular-shaped median area between the key matrices. As shown in section A-A, the space bar has a touch sensor TS disposed below a shell 101 of the space bar, which may be formed of plastic or other material. The touch sensor is able to operate effectively even when there is a substantial separation (10 mm or more) between the user's thumb and the touch sensor, so long as the intervening material is non-conductive.

The top surface of the space bar may be smooth or featured, an example of such featuring being perforations. Preferably, indicia are formed so as to be visible on or through the surface of the space bar. The indicia may be screen printed, formed as part of a decal, molded, laser-etched, etc.

In one mode of operation, the user operates the touchpad with the user's thumb, e.g., the thumb of the user's dominant hand. On each half of the space bar, an icon (such as a mouse icon) and coordinate axes appear. The icon alerts the user to the pointing function of the space bar. The coordinate axes show the directions of thumb movement that result in vertical and horizontal movement of the cursor. The axes are shown skewed at an angle, matching the orientation of the user's hands when using a typical split keyboard. In the center of the space bar, a scroll area may be provided, indicated by the vertical two-headed arrow.

Mouse “buttons” may be simulated by tapping the surface of the space bar without actually depressing the space bar. The dominant thumb may be used as the default button (“left click”) and the non-dominant thumb may be used as the optional button (“right click”). If desired, additional “buttons” may be provided at the corners of each half of the space bar, e.g., buttons 1-4 on the right and buttons I-IV on the left. Software may be provided to allow these buttons to be user-programmed.

In other embodiments, the effect of a mouse button may be obtained by in fact drepressing the space bar. Or, the space bar may be constructed to have a first degree of depression corresponding to a mouse key input and a second degree of depression corresponding to input of the space character.

Referring to FIG. 2, a block diagram is shown of one example construction of the keyboard of FIG. 1. A key matrix (matrices) 201 is (are) coupled to a first driver circuit 203. A touch sensor 205 (situated as in FIG. 1) is coupled to a second driver circuit 207. The touch sensor is preferably a capacitive touch sensor. The first driver circuit and the second driver circuit are coupled to a microcontroller 209. The microcontroller is coupled to a USB controller 211 and an associated USB connector 213. A USB cable (not shown) is used to connect the keyboard to a computer.

Optionally, the touch sensor may be provided with multi-touch capability to allow for user input using both thumbs simultaneously. For example, a continued touch using the non-dominant thumb may serve to keep an object selected during the absence of touch by the dominant thumb. As another example, the thumbs may be used together for 3-D manipulations of objects.

It will be appreciated by those of ordinary skill in the art that the present invention can be embodied in other specific forms without departing from the spirit or essential character thereof. The described embodiments are therefore considered in all respects to be illustrative and not restrictive. The scope of the invention is given by the appended claims, not the foregoing description, and all changes which come within the meaning and range of equivalents thereof are intended to be embraced therein.

What is claimed is:

1. A computer keyboard having a space bar incorporating a touch sensor used to move a cursor in two dimensions.

2. The computer keyboard of claim 1, wherein the touch sensor is a capacitive touch sensor.

3. The computer keyboard of claim 2, wherein the touch sensor is situated beneath a shell of the space bar.

4. A computer interface method using a keyboard having a space bar incorporating a touch sensor, comprising:
receiving touch input through the touch sensor; and
responsive to the touch input, producing signals for moving a cursor in two dimensions.

5. The method of claim 4, comprising:
simulating a mouse button by detecting application of a touch followed shortly thereafter by withdrawal of the touch without the space bar being depressed to create an input as the result of switch closure.

6. The method of claim 4, comprising:
simulating a mouse button by detecting application of a touch followed shortly thereafter by withdrawal of the touch in one of a plurality of predetermined areas without the space bar being depressed to create an input as the result of switch closure.

7. The method of claim 4, wherein the plurality of predetermined areas arc located at a periphery of the space bar.

8. The method of claim 4, wherein the plurality of predetermined areas are located in a region adjoining a center line of the space bar.

9. The method of claim 4, comprising detecting a touch that is moved along a center line of space bar and responsive thereto producing signals for scrolling contents of a computer display.
